(19) United States
(12) Patent Application Publication
(10) Pub. No.: US 2017/0169435 A1
(43) Pub. Date: Jun. 15, 2017

(54) METHOD AND SYSTEM FOR AUTHORIZING A TRANSACTION

(71) Applicant: Via International Service Association, San Francisco, CA (US)

(72) Inventors: Alan Joseph O'Regan, Cape Town (ZA); Horatio Nelson Huxham, Kenridge, Bellville (ZA); Hough Arie Van Wyk, CApe Town (ZA); Tara Anne Moss, Cape Town (ZA)

(73) Assignee: Via International Service Association, San Francisco, CA (US)

(21) Appl. No.: 15/115,576

(22) PCT Filed: Jan. 29, 2015
(86) PCT No.: PCT/IB2015/050674

§ 371 Date: Jul. 29, 2016

(30) Foreign Application Priority Data
Jan. 31, 2014 (ZA) 2014/00750

(51) Int. Cl. G06Q 20/40; G06Q 20/12; G06Q 20/34; G06Q 20/32

(52) U.S. Cl. CPC G06Q 20/40145; G06Q 20/3224; G06Q 20/12; G06Q 20/3276; G06Q 20/34

(57) ABSTRACT

Systems and methods for authorizing a transaction are disclosed. In a method a remotely accessible server receives biometric data from a communication device. The biometric data is gathered directly by the communication device from an individual at a merchant's premises. The server receives environmental data unique to the merchant and having been obtained at the merchant's premises. The server identifies a stored individual's profile associated with a biometric data record substantially matching the received biometric data and verifies the received environmental data against stored environmental data. If a stored individual's profile is identified and the environmental data is verified, the server authorizes the transaction.

### CROSS-REFERENCES TO RELATED APPLICATIONS

This application claims priority to South African provisional patent application no. 2014/00750, which is incorporated by reference herein.

### FIELD OF THE INVENTION

The invention relates to methods and systems for authorizing a transaction and, in particular, to methods and systems for authorizing a transaction using biometric data gathered from an individual.

### BACKGROUND

Establishing an identity of a person is important in many different scenarios. In particular, this is necessary when using banking or financial facilities. This is encompassed by Know Your Customer (KYC) data which is required by most jurisdictions to be provided by a customer when opening an account with a bank or other financial institution. KYC data generally includes passport or identification card documents and additional information to be stored against a customer registration.

Some financial services providers require that a photograph of the customer is included in customer registration data. For example, PayPal (PayPal is a registered trade mark of PayPal Pte Ltd) require an identifying photograph for some of their financial commerce services.

A merchant or agent present at a financial transaction may require authentication of a customer. In known systems, this may include a user identifying himself to the agent by supplying his phone number. The phone number may be used by a backend system to provide an identification number, such as a passport number or identification document number, which can be verified by the agent against a physical document.

This has the disadvantage that a customer must carry a physical document with him which may be vulnerable to loss, theft, etc. In addition, a user may not wish to disclose his phone number or exchange other credentials with an unknown merchant or agent.

Increasingly, merchant and other financial agents operate using mobile communication devices such as smart mobile phones making the provision of point of sale terminals redundant. This is increasingly the case where mobile money transactions are carried out which do not require a physical payment card to be present.

Positively identifying the customer for mobile money transactions, as well as physical card transactions, increases the protection of the merchant or agent as they are sure of the identity of the customer and increases the protection of customers by reducing identity theft.

However, there exist scenarios where fraudulent transactions may be submitted by unauthorized merchants either posing as actual merchants and hoodwinking unknowing customers or by using fraudulently obtained payment credentials.

Accordingly, there may also be a need to positively identify merchants to one or both of the backend or the customers.

### BRIEF SUMMARY

In accordance with a first aspect of the invention, there is provided a method for authorizing a transaction conducted at a remotely accessible server, the method comprising the steps of: receiving biometric data from a communication device, wherein the biometric data is gathered directly by the communication device from an individual at a merchant's premises; receiving environmental data unique to the merchant, the environmental data having been obtained at the merchant's premises; identifying a stored individual's profile associated with a biometric data record substantially matching the received biometric data; verifying the received environmental data against stored environmental data; and, if a stored individual's profile is identified and the environmental data is verified, authorizing the transaction.

A further feature provides for the biometric data to be one or more of the group of: individual fingerprints, thumbprints, palm records, facial records, iris records, and voice records.

Still further features provide for the biometric data to include the environmental data; for the biometric data to be included in an image and for the environmental data to be at least a portion of the image.

A yet further feature provides for the environmental data to be one or both of: at least a portion of an image which uniquely identifies the merchant; and, location data recorded in an image, the location data corresponding to a location of the merchant's premises.

Further features provide for the at least a portion of an image to include one or more of the group of: at least a portion of an image showing the merchant, at least a portion of an image showing a unique display on the merchant's premises, and at least a portion of an image showing a dynamic display.

The dynamic display may include one or more of: a dynamic graphical code, a daily newspaper and, a television frame. The unique display may include one or more of: a furnishing arrangement, a shelving arrangement, a product arrangement, a graphical code, a view of the merchant's premises and, a view from the merchant's premises.

A further feature provides for verifying the received environmental data against stored environmental data to include identifying a stored merchant profile associated with an environmental data record substantially matching the received environmental data.

Further features provide for identifying a stored merchant profile associated with an environmental data record substantially matching the received environmental data to include: identifying a stored merchant profile associated with the communication device from which the biometric data is received; and, comparing the received environmental data with environmental data associated with the stored merchant profile.

Yet further features provide for the method to include registering an individual's profile including at least one individual identification document, image data in the form of at least one photographic image of the face of the individual, and biometric data in the form of at least one biometric data record of the individual.

Further features provide for receiving biometric data to receive raw biometric data and for the method to include forwarding the raw biometric for processing to a processed level suitable for comparison with a stored biometric data record.

Still further features provide for the method to include steps of: transmitting a request for additional forms of biometric data; receiving additional forms of biometric data; and, comparing the received additional forms of biometric data with the biometric data associated with the individual's record.

Transmitting a request for additional forms of biometric data may request the additional forms of biometric data in a random order.

In one embodiment the environmental data is received responsive to the step of transmitting a request for additional forms of biometric data, and the received additional forms of biometric data include the environmental data.

Further features provide for the additional forms of biometric data to be included in an image, and for the environmental data to be at least a portion of the image.

Yet further features provide for the step of authorizing the transaction to include retrieving a photographic image of the individual associated with the individual's profile, transmitting the photographic image to the mobile communication device for visual display thereon, and receiving a transaction authorization confirmation or denial message from the mobile communication device.

In accordance with a second aspect of the invention, there is provided a method for authorizing a transaction conducted at a mobile communication device, the method comprising the steps of: obtaining biometric data from an individual directly using the mobile communication device at a merchant's premises; obtaining environmental data at the merchant's premises being unique to the merchant; transmitting the biometric data and environmental data to a remotely accessible server; and, if the remotely accessible server identifies a stored individual's profile and verifies the environmental data, receiving a transaction authorization from the remotely accessible server.

A further feature provides for the biometric data to be one or more of the group of: individual fingerprints, thumbprints, palm records, facial records, iris records, and voice records.

Still further features provide for the biometric data to include the environmental data; for the biometric data to be included in an image and for the environmental data to be at least a portion of the image.

A yet further feature provides for the environmental data to be one or both of: at least a portion of an image which uniquely identifies the merchant; and, location data recorded in an image, the location data corresponding to a location of the merchant's premises.

Further features provide for the at least a portion of an image to include one or more of the group of: at least a portion of an image showing the merchant, at least a portion of an image showing a unique display on the merchant's premises, and at least a portion of an image showing a dynamic display.

The dynamic display may include one or more of: a dynamic graphical code, a daily newspaper and, a television frame. The unique display may include one or more of: a furnishing arrangement, a shelving arrangement, a product arrangement, a graphical code, a view of the merchant's premises and, a view from the merchant's premises.

Further features provide for the method to include: receiving a request from the server for additional forms of biometric data; obtaining additional forms of biometric data from the individual directly using the mobile communication device; and, transmitting the additional forms of biometric data to the server, wherein the additional forms of biometric data are requested in a random order.

Yet further features provide for the step of receiving a transaction authorization to include: receiving a photographic image of the individual from the remotely accessible server, wherein the photographic image received from the server is associated with a stored individual's profile registered at the server and associated with a biometric data record substantially matching the obtained biometric data; displaying the photographic image on the mobile communication device for visual display thereon, enabling an operator of the mobile communication device to compare the displayed image with the individual from whom the biometric data was gathered; and, transmitting a transaction authorization confirmation or denial message to the remotely accessible server.

A further feature provides for obtaining biometric data from an individual directly using the mobile communication device to include using a biometric capturing capability provided by the mobile communication device.

A yet further feature provides for the method to include: obtaining an image of the individual by the mobile communication device and automatically comparing the obtained image with the received photographic image.

In accordance with a third aspect of the invention, there is provided a system for authorizing a transaction, including a remotely accessible server comprising: a biometric data receiving component for receiving biometric data from a communication device, wherein the biometric data is gathered directly by the communication device from an individual at a merchant's premises; an environmental data receiving component for receiving environmental data unique to the merchant, the environmental data having been obtained at the merchant's premises; an identifying component for identifying a stored individual's profile associated with a biometric data record substantially matching the received biometric data; a verifying component for verifying the received environmental data against stored environmental data; and, an authorization component for, if a stored individual's profile is identified and the environmental data is verified, authorizing the transaction.

A further feature provides for the biometric data to be one or more of the group of: individual fingerprints, thumbprints, palm records, facial records, iris records, and voice records.

Still further features provide for the biometric data to include the environmental data; for the biometric data to be included in an image and for the environmental data to be at least a portion of the image.

A yet further feature provides for the environmental data to be one or both of: at least a portion of an image which uniquely identifies the merchant; and, location data recorded in an image, the location data corresponding to a location of the merchant's premises.

Further features provide for the at least a portion of an image to include one or more of the group of: at least a portion of an image showing the merchant, at least a portion of an image showing a unique display on the merchant's premises, and at least a portion of an image showing a dynamic display.

The dynamic display may include one or more of: a dynamic graphical code, a daily newspaper and, a television frame. The unique display may include one or more of: a furnishing arrangement, a shelving arrangement, a product arrangement, a graphical code, a view of the merchant's premises and, a view from the merchant's premises.

A further feature provides for the identifying component to include: a database searching component for identifying an individual's profile stored in a database and associated with a biometric data record substantially matching the received biometric data; and, a retrieving component for obtaining a photographic image of the individual associated with the individual's profile.

A still further feature provides for the remotely accessible server to include: a registration component for registering an individual's profile including at least one individual identification document, image data in the form of at least one photographic image of the face of the individual, and biometric data in the form of at least one biometric data record of the individual.

A yet further feature provides for the remotely accessible server to include: an additional verification component for: transmitting a request for additional forms of biometric data; receiving additional forms of biometric data; and, comparing the received additional forms of biometric data with the biometric data associated with the individual's record.

The additional verification component may request the additional forms of biometric data in a random order.

Yet further features provide for the environmental data receiving component to receive the environmental data responsive to the additional verification component transmitting a request for additional forms of biometric data, and for the received additional forms of biometric data to include the environmental data.

A still further feature provides for the additional forms of biometric data to be included in an image, and for the environmental data to be at least a portion of the image.

A yet further feature provides for the authorization component to transmit a photographic image to the mobile communication device for visual display thereon, enabling an operator of the mobile communication device to visually compare the displayed image with the individual from whom the biometric data was gathered, and receive a transaction authorization confirmation or denial message from the mobile communication device.

Further features provide for the system to include a biometric processing server for receiving biometric data in a raw form and processing the biometric data to a processed level suitable for comparison with a stored biometric data record.

Yet further features provide for the system to include a mobile communication device including: a biometric capturing device incorporated into the mobile communication device for obtaining biometric data directly from an individual at a merchant's premises; an environmental capturing device for obtaining environmental data at the merchant's premises being unique to the merchant; and, a communication component for: transmitting the biometric data and environmental data to a remotely accessible server; and, if the remotely accessible server identifies a stored individual's profile and verifies the environmental data, receiving a transaction authorization from the remotely accessible server.

In accordance with fourth aspect of the invention, there is provided a mobile communication device for authorizing a transaction, the mobile communication device comprising: a biometric capturing device incorporated into the mobile communication device for obtaining biometric data directly from an individual at a merchant's premises; an environmental capturing device for obtaining environmental data at the merchant's premises being unique to the merchant; and, a communication component for: transmitting the biometric data and environmental data to a remotely accessible server; and, if the remotely accessible server identifies a stored individual's profile and verifies the environmental data, receiving a transaction authorization from the remotely accessible server.

A further feature provides for the biometric data to be one or more of the group of: individual fingerprints, thumbprints, palm records, facial records, iris records, and voice records.

Still further features provide for the biometric capturing device and environmental capturing device to be the same device; for the biometric data to include the environmental data; for the biometric data to be included in an image and for the environmental data to be at least a portion of the image.

A yet further feature provides for the environmental data to be one or both of: at least a portion of an image which uniquely identifies the merchant; and, location data recorded in an image, the location data corresponding to a location of the merchant's premises.

Further features provide for the at least a portion of an image to include one or more of the group of: at least a portion of an image showing the merchant, at least a portion of an image showing a unique display on the merchant's premises, and at least a portion of an image showing a dynamic display.

The dynamic display may include one or more of: a dynamic graphical code, a daily newspaper and, a television frame. The unique display may include one or more of: a furnishing arrangement, a shelving arrangement, a product arrangement, a graphical code, a view of the merchant's premises and, a view from the merchant's premises.

Further features provide for the communication component to receive a transaction authorization including a photographic image of the individual from the remotely accessible server, wherein the photographic image received from the server is associated with an individual's profile registered at the server and associated with a biometric data record substantially matching the obtained biometric data; for the mobile communication device to include a display for visually displaying the photographic image on the mobile communication device, enabling an operator of the mobile communication device to compare the displayed image with the individual from whom the biometric data was gathered; and for the communication component to transmit a transaction authorization confirmation or denial message to the remotely accessible server.

A yet further feature provides for the mobile communication device to include an additional request component for: receiving and processing a request from the server to obtain additional forms of biometric data; obtaining additional forms of biometric data; and, transmitting the additional forms of biometric data to the server, wherein the additional forms of biometric data are requested in a random order, including providing a prompt on a display for the additional forms of biometric data.

Still further features provide for the additional forms of biometric data to include the environmental data, and for transmitting the environmental data to transmit the additional forms of biometric data including the environmental data.

A yet further feature provides for the additional forms of biometric data to be included in an image, and for the environmental data to be at least a portion of the image.

The biometric capturing device incorporated into the mobile communication device may be in the form of one of the group of: a high-resolution camera, a high-sensitivity microphone, a touch-sensitive screen with fingerprint sensing capability, and a button having fingerprint sensing capability.

A further feature provides for the environmental capturing device to include a camera which is further for obtaining an image of the individual by the mobile communication device; and for the mobile communication device to include a comparison component for automatically comparing the obtained image with the received image data.

In accordance with a fifth aspect of the invention, there is provided a computer program product for authorizing a transaction, the computer program product comprising a computer-readable medium having stored computer-readable program code for performing the steps of: receiving biometric data from a communication device, wherein the biometric data is gathered directly by the communication device from an individual at a merchant's premises; receiving environmental data unique to the merchant, the environmental data having been obtained at the merchant's premises; identifying a stored individual's profile associated with a biometric data record substantially matching the received biometric data; verifying the received environmental data against stored environmental data; and, if a stored individual's profile is identified and the environmental data is verified, authorizing the transaction.

In accordance with a sixth aspect of the invention, there is provided a computer program product for authorizing a transaction, the computer program product comprising a computer-readable medium having stored computer-readable program code for performing the steps of: obtaining biometric data from an individual directly using the mobile communication device at a merchant's premises; obtaining environmental data at the merchant's premises being unique to the merchant; transmitting the biometric data and environmental data to a remotely accessible server; and, if the remotely accessible server identifies a stored individual's profile and verifies the environmental data, receiving a transaction authorization from the remotely accessible server.

Further features provide for the computer-readable medium to be a non-transitory computer-readable medium and for the computer-readable program code to be executable by a processing circuit.

### BRIEF DESCRIPTION OF THE DRAWINGS

FIG. 1 is a schematic diagram illustrating a system according to embodiments of the invention;

FIG. 2 is a swim-lane flow diagram illustrating a method according to embodiments of the invention;

FIG. 3 is a block diagram of a system including a remotely accessible server according to an embodiment of the invention;

FIG. 4 is a block diagram of a mobile communication device according to an embodiment of the invention;

FIG. 5 is a schematic diagram which illustrates another exemplary system for authorizing a transaction;

FIG. 6 is a swim-lane flow diagram which illustrates exemplary methods for authorizing a transaction;

FIG. 7 illustrates an example of a computing device in which various aspects of the disclosure may be implemented; and,

FIG. 8 shows a block diagram of a communication device that may be used in embodiments of the disclosure.

### DETAILED DESCRIPTION

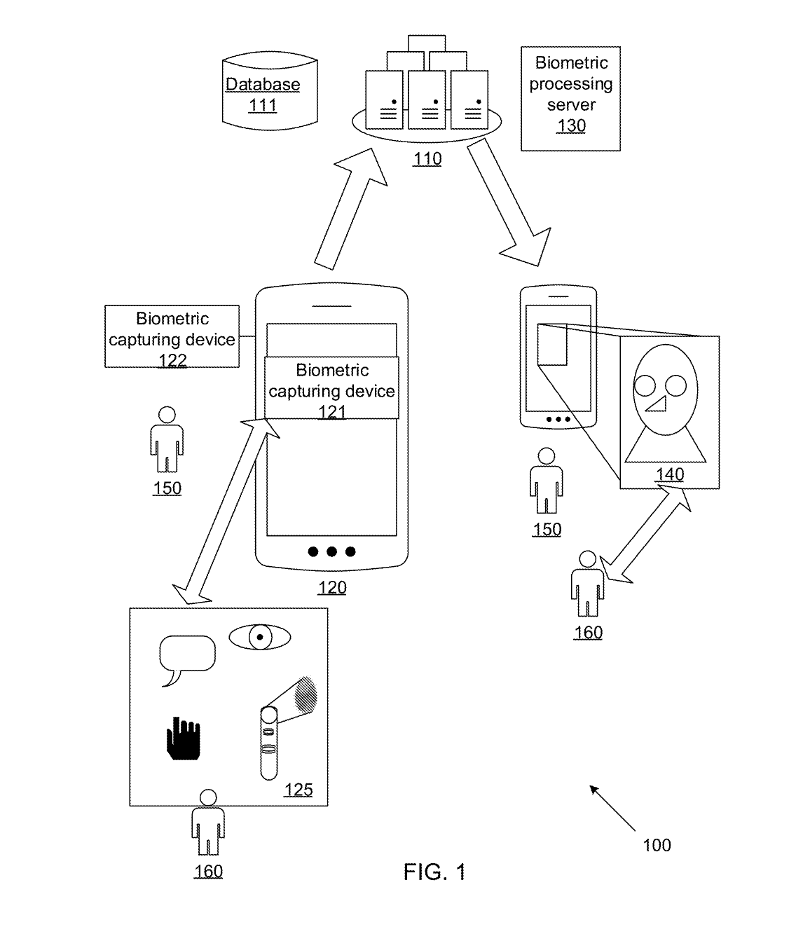

FIG. 1 illustrates an exemplary system (100) for authorizing a transaction as described herein. The system may be used in various different scenarios in which an individual's identity is required to be verified. In one example application, the individual may be a customer wishing to carry out a monetary transaction. In another example, the individual may be requesting access to information or a location.

The system (100) includes a remotely accessible server (110) which has access to stored information relating to the identity of individuals. The stored information may be provided in a database (111) at or in communication with the server (110) from which the server (110) may search and retrieve information. The remotely accessible server (110) may be a server of a financial or banking institution, a server of a personnel department of a corporation or organisation, or a security server for individuals having some form of security clearance, or any other server storing identity information. The stored information may include information in the form of know your customer (KYC) information such as copies of passports, identity documents, driver's licenses, etc.

In the described system, the server (110) may register an individual by collecting information to be stored in the database (111). The information may include documentary information, for example, in the form of KYC information such as copies of passports, identity documents, driver's licenses, etc., other identifying information may also be registered such as a telephone numbers, email address and other contact information.

Additional information may also be provided at the registration of an individual to be used in the described system and method. The registration process may be carried out at the server (110) or remotely with the additional information transmitted to the server (110) for storing in the database (111) in association with the individual's other identifying records and documents.

The additional information includes at least one photograph of the individual, preferably showing the individual's face in a full frontal image, with optional additional photographs showing different expressions (for example, smiling), the individual's profile, full body photograph, etc.

The additional information also includes at least one biometric data record of the individual. The biometric data may be gathered at a registration process of the individual with the organisation to which the server (110) is affiliated. The form of the biometric data which is gathered and stored may take various forms. Further details of the biometric data forms are discussed below, and generally these may include records of fingerprints of each finger, thumbprints of each thumb, each palm of the hands, each iris, each retina, face geometry, voice. The additional information may include more than one form of biometric data.

The remotely accessible server (110) may also have access to stored environmental data. The environmental data may be used by the server (110) for a number of purposes including, authenticating an operator, verifying an operator or an operator's premises, guarding transaction authorizations against replay attacks, ensuring that the individual and operator are co-located and so on. The term “operator” is used broadly herein and extends to a merchant with whom the individual is transacting, employees or agents of a merchant or an organization controlling a resource, and the like.

The stored environmental data may be in the form of images which uniquely identify the operator and/or the operator's premises. Other examples include images showing a unique display on the operator's premises, such as a furniture layout within the operator's premises, shelving or product arrangements or a unique insignia, such as a bar-code, designed specifically for the purposes of uniquely identifying the operator. In some cases, environmental data stored at the server may extend to rules relating to dynamic data which the server can use to verify received environmental data including dynamic data. The rules may for example relate to identifying a portion of a received image showing a newspaper and identifying the currency of the newspaper by, for example, considering a date thereon or a headline thereof. By way of another example, the rules relating to the dynamic data may include rules for identifying a television frame in the background of a received image, which may be usable for time stamping. In one embodiment, the stored environmental data may include location data which may be used to validate location data included in a received image file.

The stored environmental data may be associated with an operator profile in the database (111). The operator profile may have other information relating to the identity of operator associated therewith. This additional information may include information relating to the identity of the operator such as an address of the operator's premises, the name and other particulars of the operator, a communication address of a communication device of the operator and the like. In some cases, financial details of the operator may also be associated with the operator's profile.

The system (100) also includes a mobile communication device (120). The mobile communication device (120) may be a smart phone or a tablet which is easily transportable and has wireless communication with the remotely accessible server (110) such that data may be transmitted and received to and from the server (110). This wireless communication may be via a communication network such as the Internet, mobile phone network, etc.

The mobile communication device (120) in this embodiment is operated by an operator (150) in physical proximity to an individual (160) whose identity is to be verified. In one embodiment, the operator (150) may be a merchant in a retail environment to whom the individual (160) wishes to make a payment requiring authorization for the transaction from the server (110). The payment may be using a card-less mobile money service in which authorization and identification of the individual (160) is required. In another embodiment, the operator (150) may be requiring verification of an individual's (160) identity before providing access to a location or information. In other embodiments, the mobile communication device may be operated by an individual. Embodiments where both the operator and individual operate mobile communication devices are also anticipated.

The mobile communication device (120) includes at least one form of biometric capturing device (121) operable to gather biometric data (125) from the individual (160).

In one embodiment, the at least one form of biometric capturing device (121) is incorporated into the mobile communication device (120). The mobile communication device (120) may have a first biometric capturing device in the form of a sensitive touch screen or a dedicated button which can record a fingerprint or a thumbprint. The mobile communication device (120) may have a second biometric capturing device in the form of a high resolution camera for recording images of a palm, iris, or face. The mobile communication device (120) may have a third biometric capturing device in the form of a high sensitivity microphone for recording voice. The mobile communication device (120) may have any one or more of the first, second and third biometric capturing devices.

In a second embodiment, the at least one form of biometric capturing device (122) may be an auxiliary device which is attachable to the mobile communication device (120).

The biometric capturing devices (121, 122) may gather the information which may be processed at the mobile communication device (120) or which may be transmitted in raw form for processing at the remotely accessible server (110), or for processing at a remotely accessible biometric processing server (130) dedicated to processing biometric data. The processing may take various different forms depending on the type of biometric data and is well documented in the art.

The mobile communication device (120) may gather one or more biometric data records from the individual and may transmit the biometric data records to the server (110). In some instances, gathering the biometric data includes gathering environmental data unique to the operator. In particular, gathering the biometric data may in some instances include taking a photograph of the individual's face, with environmental data being present in the background of the image. This may be conducted in addition to gathering other forms of biometric data from the individual, such as fingerprint data or the like. In other cases, the environmental data may be specifically requested. In other embodiments, environmental data may be captured by an environmental capturing device provided with the mobile communication device.

The server (110) may carry out a search of the database (111) to find a match for the one or more biometric records. Similarly, the server (110) may search the database (111) for matching environmental data so as to identify an operator profile. Searching the database (111) to identify an operator profile may be performed to ensure that the individual is in fact physically proximate the operator. In other cases, this may be to ensure that the request is in fact received from the operator's communication device. Initially, a first biometric data record may be used with additional records referred to for verification or in the event that no match is found for the first record.

The optional biometric processing server (130) may be used to extract the biometric data from a raw biometric data record provided by the mobile communication device (120) and may also be used to compare an extracted biometric data record with stored biometric data for detailed comparison.

In one embodiment, once a match to a stored biometric data record and a stored environmental data record has been established, an associated stored photographic image of the individual is retrieved from the database (111) and transmitted to the mobile communication device (120). The mobile communication device (120) may receive and display the photographic image (140) on a display screen of the mobile communication device (120).

The operator (150) may visually compare the displayed image (140) with the individual (160) in front of him. The operator may verify or deny via the mobile communication device (120) that the individual (160) is the same person as shown in the displayed image (140) thereby approving the authorization or denying it.

In some embodiments, the server (110) may request further verification by requesting additional biometric data (125) from the individual (160). This request may randomly select additional biometric data requirements and the order in which these are to be supplied. For example, a random order of different fingerprints may be requested in which case the individual may provide each fingerprint in order to be recorded at the mobile communication device (120). In an alternative example, multiple designated fingerprints may be requested simultaneously.

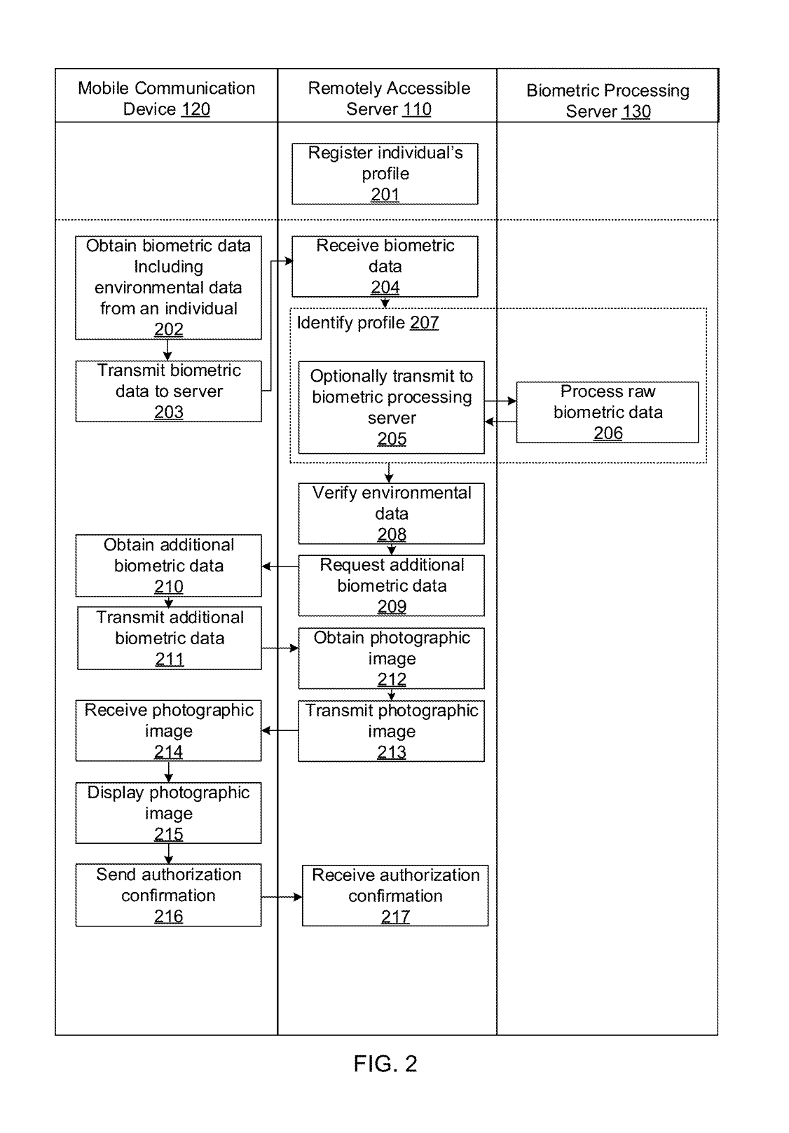

Referring to FIG. 2, a swim-lane flow diagram shows an example embodiment of the methods carried out at the mobile communication device (120) and the remotely accessible server (110), and optionally at an additional biometric processing server (130).

A registration process may be carried out for an individual with the server (110). The registration process may register (201) an individual's profile including at least one individual identification document, such as a passport, ID document, driver's license or the like, at least one facial image, and at least one form of biometric data.

In use, when an individual is to be authorized by an operator of the mobile communication device (120), the mobile communication device (120) obtains (202) biometric data from the individual. The biometric data may be one or more biometric records obtained from the individual and may be in a processed or raw form. The biometric data in this exemplary scenario is an image showing, for example, the individual's face, palm or iris. The biometric data includes environmental data unique to the operator. The environmental data may be a portion of the image, for example the background, which may be capable of being uniquely associated with the operator. The environmental data may for example be a product display, a view from the operator's premises, the operator's face, a furnishing arrangement or the like, which is visible in the background of the image, and which has been previously been recorded with the server (110) and associated with the operator's profile. The biometric data including the environmental data is transmitted (203) to the remotely accessible server (110).

Data transmitted between the remotely accessible server (110) and the mobile communication device (120) may be encrypted. This prevents biometric data and environmental data from being compromised during transit.

The server (110) receives (204) the biometric data including the environmental data and identifies (207) an individual's profile associated with the biometric data. This may include transmitting (205) the received biometric data to a biometric processing server (130) for processing (206) of raw biometric data and matching to stored biometric records. Identifying (207) an individual's profile may include substantially matching the biometric data to stored biometric data and retrieving an individual's profile from a database. The server (110) may also verify (208) the received environmental data against the stored environmental data. In some embodiments, this may include identifying a stored operator profile associated with an environmental data record substantially matching the received environmental data. In other cases, the operator profile may be identified using an address of the communication device (120), with the environmental data being used as a further verification. If the environmental data is not verified, the server (110) may prevent the transaction from proceeding.

The server (110) may request (209) additional biometric data from the individual. This may be before supplying the image data to the mobile communication device (120) or, alternatively, may be as an additional security check after receiving the confirmation message from the mobile communication device (120). The request (209) may include a request in a random order for multiple forms of biometric data or random combinations of biometric data. For example, fingerprints may be required in a given order or selected fingerprints simultaneously.

The mobile communication device (120) may obtain (210) the additional biometric data and transmit (211) this to the server (110). In another embodiment, the request for additional biometric data may be transmitted to a mobile communication device of the individual.

The server (110) may then obtain (212) a photographic image associated with the individual's profile and transmits (213) the photographic image to the mobile communication device (120).

The mobile communication device (120) receives (214) the image data and displays (215) the photographic image data on the mobile communication device (120) for comparison by the operator with the individual from whom the biometric data was obtained.

The mobile communication device (120) sends (216) a transaction authorization confirmation or denial message to the server (110), if required, or may proceed with the action for which confirmation of the individual's identity was required. The server (110) receives the authorization confirmation (217).

The above described system and method may enable an individual to transact by simply providing biometric data. Thus, individuals may be able to transact without the need to carry cash, a payment device such as a credit card or a mobile communication device. Furthermore, by requiring environmental data, the system and method may be capable of verifying that the individual and operator are physically proximate one another. The system and method may also be capable of ensuring that the operator's mobile communication device is indeed at the operators premises and that at least part of the biometric data—that part including environmental data—is substantially current and not replayed data from an earlier point in time. Additionally, by requiring the operator to manually verify the individual by physically comparing the individual with a photograph, issues associated with the “liveness” of the biometric data, e.g. where a photograph of a biometric is used in place of the actual individual, may be avoided.

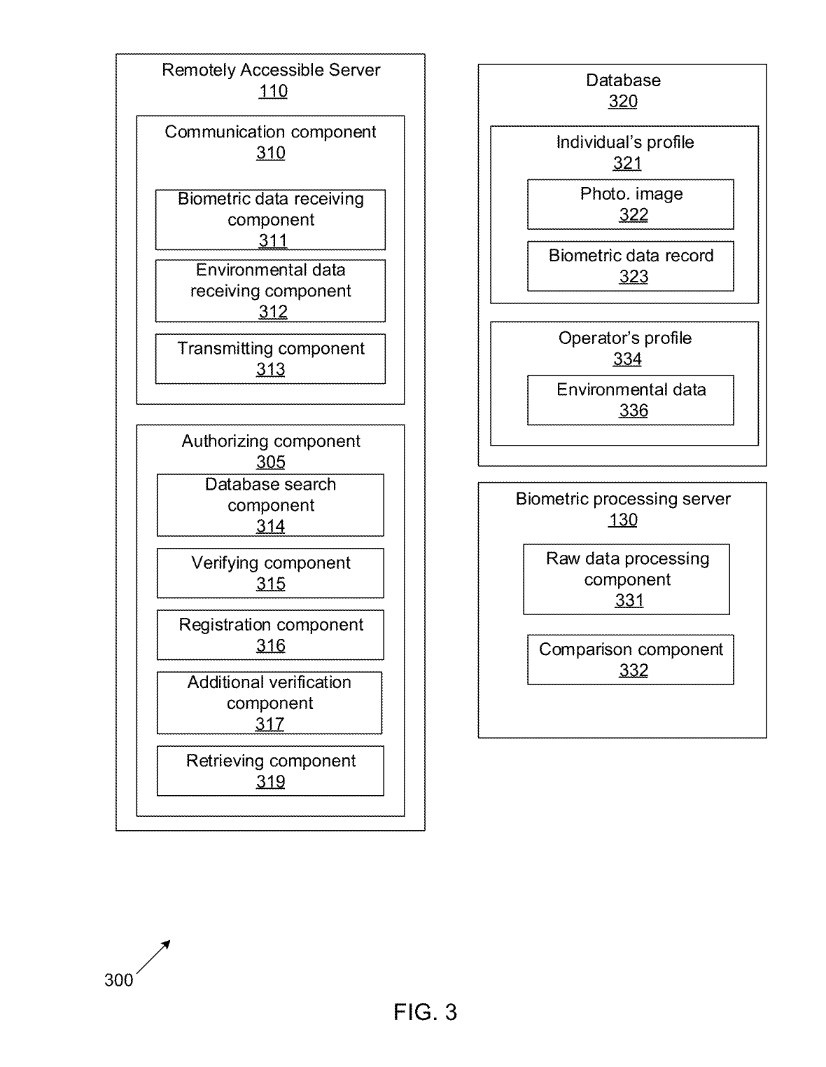

FIG. 3 illustrates an example embodiment of a system (300) including a remotely accessible server (110). The remotely accessible server (110) may be in communication with a database (320) in which records are stored including individuals' profiles (321) including at least one photographic image (322) of the individual and at least one biometric record (323) for the individual. The database (320) also stores operators' profiles (334) having environmental data (336) associated therewith.

The remotely accessible server (110) includes a communication component (310) including a biometric data receiving component (311) for receiving biometric data from a communication device and an environmental data receiving component (312) for receiving environmental data unique to an operator. The communication component (310) also includes a transmitting component (313) for transmitting messages and data to a mobile communication device (120).

The remotely accessible server (110) includes an authorization component (305) for carrying out the functionality of authorizing an individual to carry out a transaction at a mobile communication device (120).

The authorization component (305) may include a database searching component (314) for searching the database (320) in order to match received biometric data from a mobile communication device (120) with stored biometric data records (323) in individual's profiles (321).

The authorization component (305) may also include a verifying component (315) for verifying the received environmental data against stored environmental data. The verifying component (315) may verify the received environmental data against stored environmental data by identifying a stored operator profile associated with an environmental data record substantially matching the received environmental data. In some embodiments, identifying a stored operator profile associated with an environmental data record substantially matching the received environmental data includes identifying a stored merchant profile associated with the communication device from which the biometric data is received and comparing the received environmental data with environmental data associated with the stored merchant profile.

The authorization component (305) may also include a registration component (316) for registering an individual and creating and storing an individual's profile (320).

The authorization component (305) may also include an additional verification component (317) for generating and transmitting a request for additional biometric data from the mobile communication device (120). The additional verification component (317) may include a component for generating a random selection of biometric data to be requested and may compare received biometric data in response to the request with retrieved biometric data records (322) corresponding to the requested form from the individual's profile (320). The additional verification component (317) may also include a request for environmental data in the transmitted request.

The authorization component (305) may include a retrieving component (319) for, if a stored individual's profile is identified and the environmental data is verified, retrieving an individual's profile (321) from the database (320) and extracting a photographic image (322) from the individual's profile (321) for transmitting, via the transmitting component (313), to the mobile communication device (120). The authorization component (305) may also receive a transaction authorization confirmation or denial message from the mobile communication device and may authorize or decline the transaction accordingly.

Optionally, a biometric processing server (130) may be provided in the system (300) which may be provided locally or remotely to the remotely accessible server (110). The biometric processing server (130) may include a raw biometric data processing component (331) for processing raw biometric data to a form comparable to stored biometric data records (322) in the database (320). The biometric processing server (130) may include a comparison component (332) for comparing received biometric data with stored biometric data records (322). The biometric processing server (130) may also be capable of receiving raw environmental data and similarly processing the received raw environmental data to produce processed environmental data. The biometric processing server may use the biometric processing component (331) and comparison component (332) or may provide an environmental processing component and environmental comparison component for this purpose.

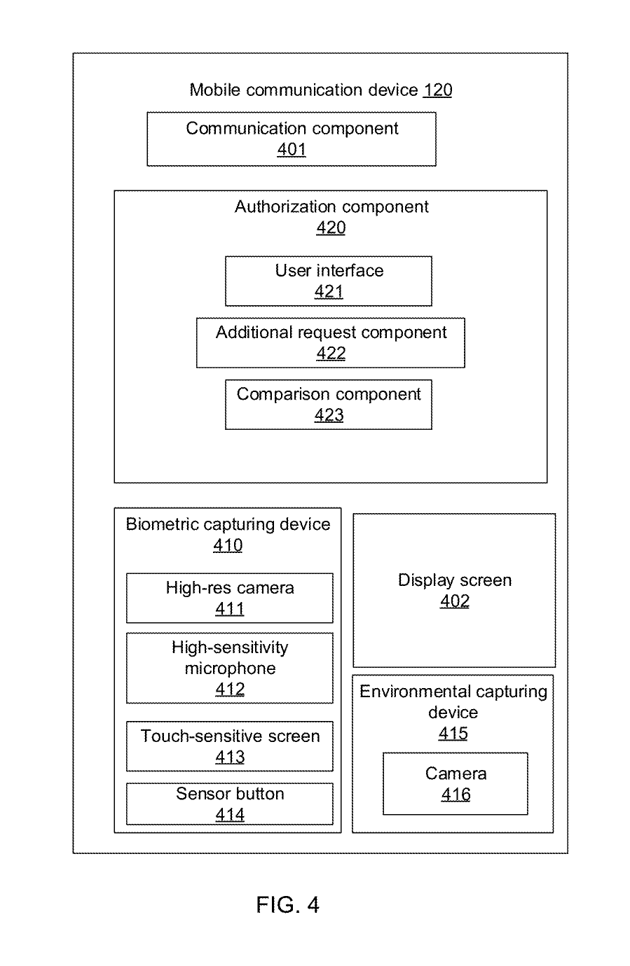

FIG. 4 illustrates an example embodiment of a mobile communication device (120). The mobile communication device (120) may include a communication component (401) for wireless communication with at least a remotely accessible server (110). The mobile communication device (120) may be in the form of a smart mobile phone or a tablet including a display screen (402) at least capable of displaying an image.

The mobile communication device (120) may also include at least one form of biometric capturing device (410) incorporated into the mobile communication device (120). A form of biometric capturing device (410) may be a high resolution camera (411) for capturing data such as iris images, palm images, etc., a high-sensitivity microphone (412) for capturing voice data, a touch sensitive screen (413) or dedicated sensor button (414) for capturing fingerprint and thumbprint data, or other forms of biometric reading device.

The mobile communication device (120) may also include an environmental capturing device (415). The environmental capturing device may include a camera (416) (which may be the same camera as the high-resolution camera used as a biometric capturing device or which may be a lower-resolution camera). The environmental capturing device (415) is for capturing an image of an individual and for gathering environmental data. In some embodiments, the biometric capturing device (410) and environmental capturing device (415) may be the same device, for example a camera or high resolution camera.

The mobile communication device (120) includes an authorization component (420) for receiving biometric data and environmental data from the biometric capturing device (410) and/or the environmental capturing device (415) and for transmitting the biometric data and environmental data to the remotely accessible server (110) and, in some embodiments, for receiving photographic image data for display. A user interface (421) of the authorization component (420) may prompt an operator or individual, as the case may be, through the process of authorization. The authorization component (420) may include an additional request component (422) for obtaining and providing additional biometric data which may include environmental data in response to a request from the remotely accessible server (110). In some embodiments, the authorization component (420) may include a comparison component (423) for comparing a received photographic image with a captured image of the individual.

In an alternative embodiment, the at least one form of biometric capturing device (410) may be provided as an attachment to the mobile communication device to provide additional biometric reading functionality.

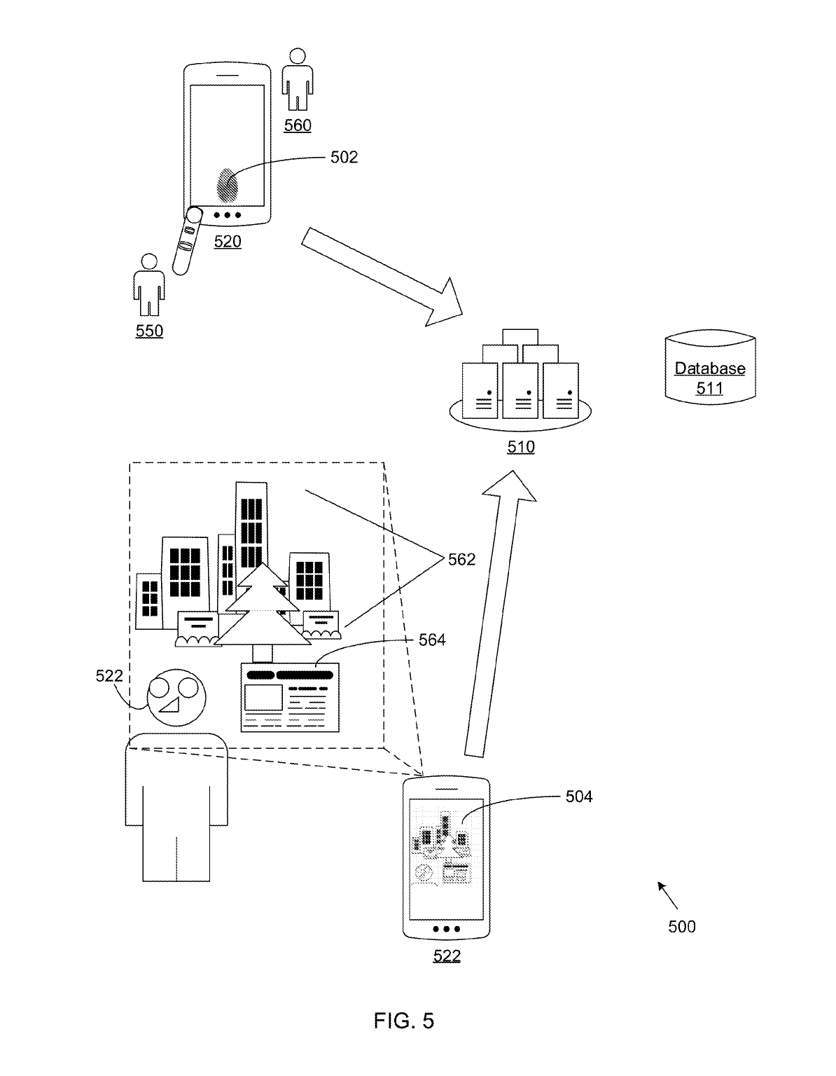

FIG. 5 is a schematic diagram which illustrates another exemplary system (500) for authorizing a transaction. The system (500) includes a remotely accessible server (510), a mobile communication device (520) of an operator (560) and a mobile communication device (522) of an individual (550). In the exemplary embodiment described, the operator is a merchant offering goods for sale and the individual is a consumer. The transaction is a monetary transaction. Other embodiments such, such as the operator being a mobile money vendor, are also anticipated. Although the entities and devices of the system (500) as illustrated are singular, it should be anticipated that an implementation may include a plurality of each of these.

The remotely accessible server (510) may be any appropriate server computer or distributed server computer and has access to a database (511) in which information relating to the individual and operator respectively is stored. The information includes an individual's profile and an operator's profile. The individual's profile at least includes a biometric data record of the individual. The individual's profile may also include a communication address, such as a phone number, of the individual's communication device (522) and payment credentials which may be used in making a payment from the individual's financial account. The operator's profile includes stored environmental data which may be unique to the operator and may be used in identifying the operator. The operator's profile may further include payment credentials or information of the operator and a communication address of the operator's communication device.

The biometric data stored in the database (511) includes one or more of the group of: individual fingerprints, thumbprints, palm records, facial records, iris records, voice records, and a combination of these records.

The environmental data stored at the database (511) includes one or both of: at least a portion of image data which uniquely identifies the operator and location data which corresponds to a location of the merchant's premises.

The stored environmental image data may include one or more of the group of: an image showing the operator, an image showing a unique display on the operator's premises, and rules or images relating to a dynamic display. The unique display may include one or more of: a furnishing arrangement, a shelving arrangement, a product arrangement, a graphical code, a view of the operator's premises and, a view from the operator's premises. The rules or images relating to a dynamic display include rules for verifying a received image showing a dynamic graphical code, a daily newspaper, a television frame and the like.

The mobile communication devices (520, 522) of the individual and operator may be any suitable electronic devices capable of communicating with the remotely accessible server (510) over a communication network. Thus the communication devices (520, 522) are capable of transmitting and receiving data, messages and the like to and from the remotely accessible server (510). Exemplary mobile communication devices include smart phones, tablet computers wearable computing devices and the like. The communication devices (520, 522) may have biometric capturing devices, at least being in the form of a camera, for gathering biometric data directly from the individual (550). In the embodiment illustrated in FIG. 5, the operator's communication device (520) also includes a biometric capturing device in the form of a fingerprint reader although in other embodiments so too may the individual's communication device (522).

The system (500) of FIG. 5 may enable the authorizing of transactions using biometric and environmental data. In one exemplary case, the operator's communication device (520) may gather biometric data in the form of a fingerprint (502) gathered directly from the individual (550). This biometric data may be transmitted to the server (510) together with a transaction authorization request and may be used thereat to identify the individual's stored profile. In some embodiments, identifying the individual's stored profile may include identifying a communication address, for example a phone number, of the individual's communication device (522) as well as payment credentials for use in the transaction.

Thus, in order to verify that the individual is in fact present at the operator's premises, the server (510) may transmit a request for additional forms of biometric data from the individual. The request may be sent to either the individual's communication device (522) or the operator's communication device (520) and includes a request for environmental data.

In the illustrated embodiment, the request is transmitted to the operator's communication device (520). The request may include instructions as to which environmental data is to be included with the additional forms of biometric data or alternatively the operator (560) may instruct the individual (550) in this regard. In the embodiment illustrated in FIG. 5 the request for additional forms of biometric data is a request for a photographic image (504) of the face of the individual (552) with environmental data in the form of a view (562) from the operator's premises included in the background of the image (504). The request also includes a request for dynamic data, in this embodiment in the form of a daily newspaper (564) which can be used by the server (510) to verify that the image was captured on the correct day. It should be appreciated that the dynamic data may take on various forms and in some embodiments may be a graphical code, such as a quick response (QR) code or the like.

This photographic image (504) may then be transmitted from the individual's communication device (522) to the server (510) which can then use the additional biometric data together with the environmental data to verify that the individual is at the operator's premises, to further authenticate the individual and to confirm the identity of the operator.

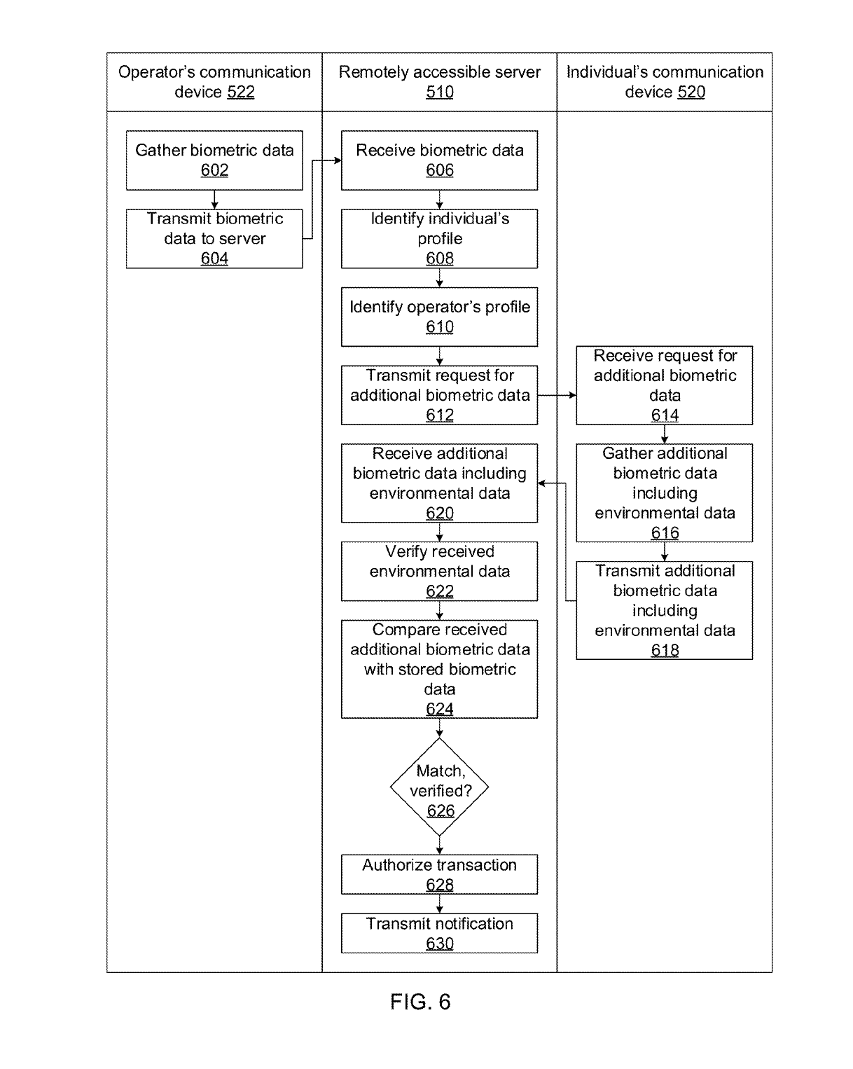

The operation of the exemplary system of FIG. 5 is explained below with reference to the swim-lane flow diagram shown in FIG. 6. The swim-lane diagram of FIG. 6 illustrates exemplary methods conducted by the mobile communication devices (520, 522) and the remotely accessible server (510) in an exemplary in-use scenario.

The scenario is described with reference to a financial transaction wherein the individual is a consumer wishing to make a purchase from the operator, being a merchant. It should, however, be anticipated that other use-cases can apply.

Once the individual has identified a product to purchase at the operator's premises, the individual may approach the operator in order to make payment for the product. At a first stage (602), the operator's mobile communication device (520) gathers biometric data directly from the individual at the operator's premises and transmits the biometric data to the server (510) at a next stage (604). The biometric data gathered may be a fingerprint, a photograph of the individual's iris, a recording of the individual's voice and the like.

The biometric data may be sent together with a transaction authorization request which may include details relating to the transaction, such as a price and details relating to the operator.

The server (510) then receives the biometric data and optionally the transaction authorization request from the communication device (520) at a next stage (606). At a following stage (608), the server (510) identifies a stored individual's profile associated with a biometric data record substantially matching the received biometric data.

The server (510) may also, at a next stage (610), identify a stored operator profile associated with the communication device (520) from which the biometric data is received, for example by using the communication address of the operator's communication device (520).

At a following stage (612), the server (510) transmits a request for additional forms of biometric data to the communication device (522) of the individual. In another embodiment, the server may transmit the request to the communication device (520) of the operator.

The communication device (522) of the individual may then receive the request for additional forms of biometric data at a next stage (614) and prompts the individual to gather the additional forms of biometric data. The request may include an instruction for the individual to take a photograph of him- or herself using a camera of the individual's communication device (522) to gather the additional forms of biometric data. The request may further include an instruction for the individual to include environmental data unique to the operator in the photographic image. The request may, for example, prompt the individual to stand in front of a particular display, include the operator in the photograph or the like. Alternatively, the operator may inform the individual as to which environmental data should be included in the photographic image.

The mobile communication device (522) of the individual then gathers the additional biometric data including the environmental data directly from the individual at a following stage (616), in this embodiment by capturing a photographic image of the individual with at least a portion of the background of the image including environmental data. At a next stage (618), the communication device (522) transmits the additional biometric data including the environmental data to the server (510). The server (510), in turn receives the biometric data and environmental data from the individual's communication device (522) at a following stage (620). In another embodiment, the server (510) may receive the additional forms of biometric data including environmental data from the operator's communication device (520).

The server (510) may then at a next stage (622) verify the received environmental data against stored environmental data associated with the operator's profile. Verifying the received environmental data against stored environmental data may include verifying that the previously identified operator's profile has an environmental data record associated therewith which substantially matches the received environmental data. This may be performed by comparing the environmental data with the stored environmental data associated with the operator's profile.

The stages (606, 620) of receiving biometric data and environmental data may receive raw biometric data and environmental data and may thus include forwarding the raw biometric and environmental data for processing to a processed level suitable for comparison with a stored biometric data record.

The server (510) may also compare the received additional forms of biometric data with the biometric data associated with the individual's record at a following stage (624).

If the additional forms of biometric data received substantially match the stored biometric data, and if the received environmental data is verified, the server (510) may then authorize the transaction at a following stage (626) and at a stage thereafter (628) transmit the transaction authorization notification to the one or both of the communication devices (520, 522) of the operator and individual.

The systems, methods and devices described herein provide certain technical advantages over the prior art. Transactions may be authorized without the need to carry a mobile device or payment card. Furthermore, merchants submitting transaction requests may also be authenticated through the inclusion of environmental data in the biometric data. Biometric data including environmental data provides composite authorization data which may be further used to ensure that a merchant and individual are sharing a physical location and thus may guard against fraudulent merchant devices submitting transaction requests.

The Figures show various embodiments of systems, methods and devices for authorizing transactions. Although different embodiments are described with reference to different Figures, it should be appreciated that the aspects, components, steps and the like of respective embodiments can apply to other embodiments mutatis mutandis.

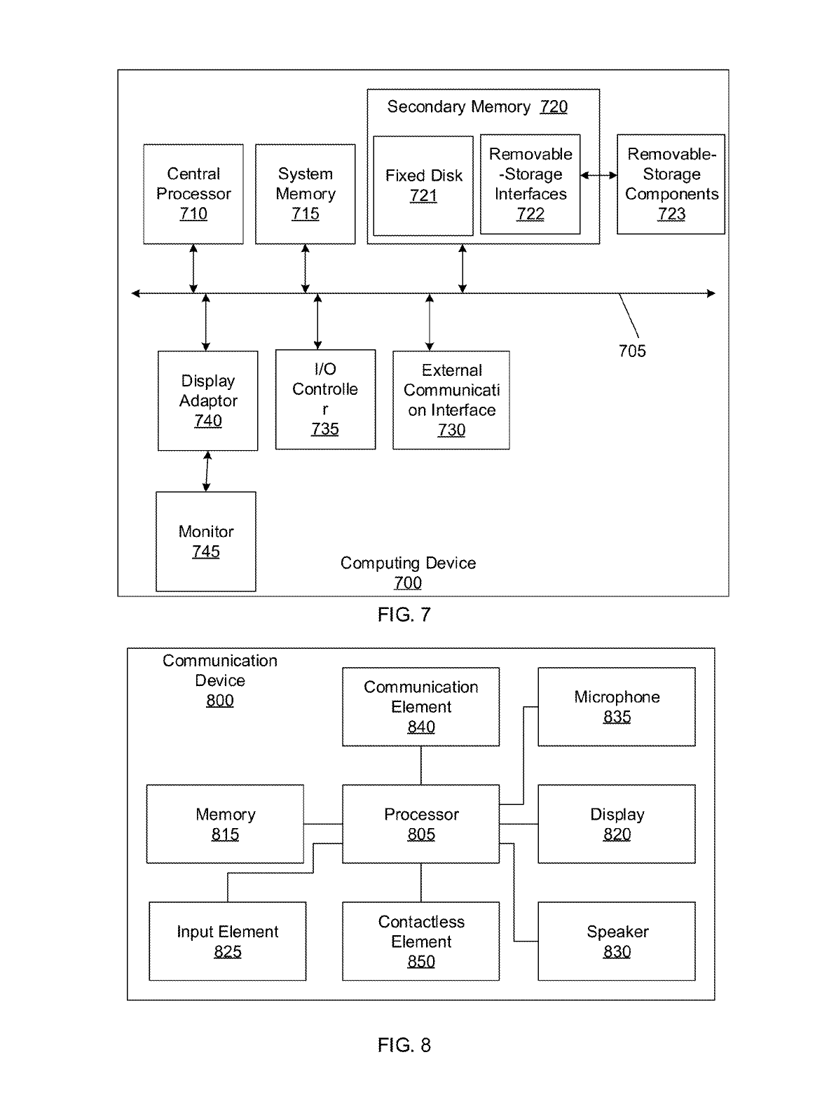

FIG. 7 illustrates an example of a computing device (700) in which various aspects of the disclosure may be implemented. The computing device (700) may be suitable for storing and executing computer program code. The various participants and elements in the previously described system diagrams may use any suitable number of subsystems or components of the computing device (700) to facilitate the functions described herein.

The computing device (700) may include subsystems or components interconnected via a communication infrastructure (705) (for example, a communications bus, a cross-over bar device, or a network). The computing device (700) may include at least one central processor (710) and at least one memory component in the form of computer-readable media.

The memory components may include system memory (715), which may include read only memory (ROM) and random access memory (RAM). A basic input/output system (BIOS) may be stored in ROM. System software may be stored in the system memory (715) including operating system software.

The memory components may also include secondary memory (720). The secondary memory (720) may include a fixed disk (721), such as a hard disk drive, and, optionally, one or more removable-storage interfaces (722) for removable-storage components (723).

The removable-storage interfaces (722) may be in the form of removable-storage drives (for example, magnetic tape drives, optical disk drives, floppy disk drives, etc.) for corresponding removable storage-components (for example, a magnetic tape, an optical disk, a floppy disk, etc.), which may be written to and read by the removable-storage drive.

The removable-storage interfaces (722) may also be in the form of ports or sockets for interfacing with other forms of removable-storage components (723) such as a flash memory drive, external hard drive, or removable memory chip, etc.

The computing device (700) may include an external communications interface (730) for operation of the computing device (700) in a networked environment enabling transfer of data between multiple computing devices (700). Data transferred via the external communications interface (730) may be in the form of signals, which may be electronic, electromagnetic, optical, radio, or other types of signal.

The external communications interface (730) may enable communication of data between the computing device (700) and other computing devices including servers and external storage facilities. Web services may be accessible by the computing device (700) via the communications interface (730).

The external communications interface (730) may also enable other forms of communication to and from the computing device (700) including, voice communication, near field communication, Bluetooth, etc.

The computer-readable media in the form of the various memory components may provide storage of computer-executable instructions, data structures, program modules, and other data. A computer program product may be provided by a computer-readable medium having stored computer-readable program code executable by the central processor (710).

A computer program product may be provided by a non-transient computer-readable medium, or may be provided via a signal or other transient means via the communications interface (730).

Interconnection via the communication infrastructure (705) allows a central processor (710) to communicate with each subsystem or component and to control the execution of instructions from the memory components, as well as the exchange of information between subsystems or components.

Peripherals (such as printers, scanners, cameras, or the like) and input/output (I/O) devices (such as a mouse, touchpad, keyboard, microphone, joystick, or the like) may couple to the computing device (700) either directly or via an I/O controller (735). These components may be connected to the computing device (700) by any number of means known in the art, such as a serial port.

One or more monitors (745) may be coupled via a display or video adapter (740) to the computing device (700).

FIG. 8 shows a block diagram of a communication device (800) that may be used in embodiments of the disclosure. The communication device (800) may be a cell phone, a feature phone, a smart phone, a satellite phone, or a computing device having a phone capability.

The communication device (800) may include a processor (805) (e.g., a microprocessor) for processing the functions of the communication device (800) and a display (820) to allow a user to see the phone numbers and other information and messages. The communication device (800) may further include an input element (825) to allow a user to input information into the device (e.g., input buttons, touch screen, etc.), a speaker (830) to allow the user to hear voice communication, music, etc., and a microphone (835) to allow the user to transmit his or her voice through the communication device (800).

The processor (810) of the communication device (800) may connect to a memory (815). The memory (815) may be in the form of a computer-readable medium that stores data and, optionally, computer-executable instructions.

The communication device (800) may also include a communication element (840) for connection to communication channels (e.g., a cellular telephone network, data transmission network, Wi-Fi network, satellite-phone network, Internet network, Satellite Internet Network, etc.). The communication element (840) may include an associated wireless transfer element, such as an antenna.

The communication element (840) may include a subscriber identity module (SIM) in the form of an integrated circuit that stores an international mobile subscriber identity and the related key used to identify and authenticate a subscriber using the communication device (800). One or more subscriber identity modules may be removable from the communication device (800) or embedded in the communication device (800).

The communication device (800) may further include a contactless element (850), which is typically implemented in the form of a semiconductor chip (or other data storage element) with an associated wireless transfer element, such as an antenna. The contactless element (850) may be associated with (e.g., embedded within) the communication device (800) and data or control instructions transmitted via a cellular network may be applied to the contactless element (850) by means of a contactless element interface (not shown). The contactless element interface may function to permit the exchange of data and/or control instructions between mobile device circuitry (and hence the cellular network) and the contactless element (850).

The contactless element (850) may be capable of transferring and receiving data using a near field communications (NFC) capability (or near field communications medium) typically in accordance with a standardized protocol or data transfer mechanism (e.g., ISO 14443/NFC). Near field communications capability is a short-range communications capability, such as radio-frequency identification (RFID), Bluetooth, infra-red, or other data transfer capability that can be used to exchange data between the communication device (800) and an interrogation device. Thus, the communication device (800) may be capable of communicating and transferring data and/or control instructions via both a cellular network and near field communications capability.

The data stored in the memory (815) may include: operation data relating to the operation of the communication device (800), personal data (e.g., name, date of birth, identification number, etc.), financial data (e.g., bank account information, a bank identification number (BIN), credit or debit card number information, account balance information, expiration date, loyalty provider account numbers, etc.), transit information (e.g., as in a subway or train pass), access information (e.g., as in access badges), etc. A user may transmit this data from the communication device (800) to selected receivers.

The communication device (800) may be, amongst other things, a notification device that can receive alert messages and access reports, a portable merchant device that can be used to transmit control data identifying a discount to be applied, as well as a portable consumer device that can be used to make payments.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The software components or functions described in this application may be implemented as software code to be executed by one or more processors using any suitable computer language such as, for example, Java, C++, or Perl using, for example, conventional or object-oriented techniques. The software code may be stored as a series of instructions, or commands on a non-transitory computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

Any of the steps, operations, or processes described herein may be performed or implemented with one or more hardware or software modules, alone or in combination with other devices. In one embodiment, a software module is implemented with a computer program product comprising a non-transient computer-readable medium containing computer program code, which can be executed by a computer processor for performing any or all of the steps, operations, or processes described.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A method for authorizing a transaction conducted at a remotely accessible server, the method comprising the steps of:
receiving biometric data from a communication device, wherein the biometric data is gathered directly by the communication device from an individual at a merchant's premises;
receiving environmental data unique to the merchant, the environmental data having been obtained at the merchant's premises;
identifying a stored individual's profile associated with a biometric data record substantially matching the received biometric data;
verifying the received environmental data against stored environmental data; and,
if a stored individual's profile is identified and the environmental data is verified, authorizing the transaction.

2. The method as claimed in claim 1, wherein the biometric data is one or more of the group of: individual fingerprints, thumbprints, palm records, facial records, iris records, and voice records.

3. The method as claimed in claim 1, wherein the biometric data includes the environmental data.

4. The method as claimed in claim 1, wherein the biometric data is included in an image and wherein the environmental data is at least a portion of the image.

5. The method as claimed in claim 1, wherein the environmental data is one or both of: at least a portion of an image which uniquely identifies the merchant; and, location data recorded in an image, the location data corresponding to a location of the merchant's premises.

6. The method as claimed in claim 5, wherein the at least a portion of an image includes one or more of the group of: at least a portion of an image showing the merchant, at least a portion of an image showing a unique display on the merchant's premises, and at least a portion of an image showing a dynamic display.

7. The method as claimed in claim 6, wherein the dynamic display includes one or more of: a dynamic graphical code, a daily newspaper and, a television frame.

8. The method as claimed in claim 6, wherein the unique display includes one or more of: a furnishing arrangement, a shelving arrangement, a product arrangement, a graphical code, a view of the merchant's premises and, a view from the merchant's premises.

9. The method as claimed in claim 1, wherein verifying the received environmental data against stored environmental data includes identifying a stored merchant profile associated with an environmental data record substantially matching the received environmental data.

10. The method as claimed in claim 9, wherein identifying a stored merchant profile associated with an environmental data record substantially matching the received environmental data includes:
identifying a stored merchant profile associated with the communication device from which the biometric data is received; and,
comparing the received environmental data with environmental data associated with the stored merchant profile.

11. The method as claimed in claim 1, including the steps of:
transmitting a request for additional forms of biometric data;
receiving additional forms of biometric data; and,
comparing the received additional forms of biometric data with the biometric data associated with the individual's record.

12. The method as claimed in claim 11, wherein the environmental data is received responsive to the step of transmitting a request for additional forms of biometric data, and wherein the received additional forms of biometric data include the environmental data.

13. The method as claimed in claim 1, wherein the step of authorizing the transaction includes retrieving a photographic image of the individual associated with the individual's profile, transmitting the photographic image to the communication device for visual display thereon, and receiving a transaction authorization confirmation or denial message from the mobile communication device.

14.-17. (canceled)

18. A system for authorizing a transaction, including a remotely accessible server comprising:
a biometric data receiving component for receiving biometric data from a communication device, wherein the biometric data is gathered directly by the communication device from an individual at a merchant's premises;
an environmental data receiving component for receiving environmental data unique to the merchant, the environmental data having been obtained at the merchant's premises;
an identifying component for identifying a stored individual's profile associated with a biometric data record substantially matching the received biometric data;
a verifying component for verifying the received environmental data against stored environmental data; and,
an authorization component for, if a stored individual's profile is identified and the environmental data is verified, authorizing the transaction.

19. The system as claimed in claim 18, wherein the remotely accessible server includes:
an additional verification component for:
transmitting a request for additional forms of biometric data;
receiving additional forms of biometric data; and,
comparing the received additional forms of biometric data with the biometric data associated with the individual's record.

20. The system as claimed in claim 19, wherein the environmental data receiving component receives the environmental data responsive to the additional verification component transmitting a request for additional forms of biometric data, and wherein the received additional forms of biometric data include the environmental data.

21. The system as claimed in claim 18, wherein the authorization component transmits a photographic image to the mobile communication device for visual display thereon, enabling an operator of the mobile communication device to visually compare the displayed image with the individual from whom the biometric data was gathered, and receives a transaction authorization confirmation or denial message from the mobile communication device.

22. The system as claimed in claim 18, including a mobile communication device including:
a biometric capturing device incorporated into the mobile communication device for obtaining biometric data directly from an individual at a merchant's premises;
an environmental capturing device for obtaining environmental data at the merchant's premises being unique to the merchant; and,
a communication component for transmitting the biometric data and environmental data to a remotely accessible server; and, if the remotely accessible server identifies a stored individual's profile and verifies the environmental data, receiving a transaction authorization from the remotely accessible server.

23.-28. (canceled)

29. A computer program product for authorizing a transaction, the computer program product comprising a computer-readable medium having stored computer-readable program code for performing the steps of:
receiving biometric data from a communication device, wherein the biometric data is gathered directly by the communication device from an individual at a merchant's premises;
receiving environmental data unique to the merchant, the environmental data having been obtained at the merchant's premises;
identifying a stored individual's profile associated with a biometric data record substantially matching the received biometric data;
verifying the received environmental data against stored environmental data; and,
if a stored individual's profile is identified and the environmental data is verified, authorizing the transaction.

30. (canceled)
